(19) United States
(12) Patent Application Publication
(10) Pub. No.: US 2024/0221319 A1
(43) Pub. Date: Jul. 4, 2024

(54) INFORMATION PROCESSING SYSTEM AND INFORMATION PROCESSING METHOD

(71) Applicant: TOYOTA JIDOSHA KABUSHIKI KAISHA, Toyota-shi (JP)

(72) Inventor: Wataru KAKU, Musashino-shi (JP)

(73) Assignee: TOYOTA JIDOSHA KABUSHIKI KAISHA, Toyota-shi (JP)

(21) Appl. No.: 18/533,680

(22) Filed: Dec. 8, 2023

(30) Foreign Application Priority Data
Dec. 28, 2022 (JP) 2022-212670

(51) Int. Cl. G06T 19/00; G06F 3/01; H04W 4/02; H04W 4/029

(52) U.S. Cl. CPC G06T 19/00; G06F 3/012; H04W 4/023; H04W 4/029; G06T 2219/024

(57) ABSTRACT

An information processing system includes a plurality of terminal apparatuses each located at a predetermined distance from each of a plurality of users, wherein the plurality of terminal apparatuses includes a first terminal apparatus located at a predetermined distance from a first user, a second terminal apparatus located at a predetermined distance from a second user, and a third terminal apparatus located at a predetermined distance from a third user, each of the plurality of terminal apparatuses is configured to display, on a display, an image of each of other users, and the first terminal apparatus is configured to detect and transmit, to the third terminal apparatus, first distance information between the first user and the second user who is displayed on the display of the first terminal apparatus.

### CROSS-REFERENCE TO RELATED APPLICATION

This application claims priority to Japanese Patent Application No. 2022-212670, filed on Dec. 28, 2022, the entire contents of which are incorporated herein by reference.

### TECHNICAL FIELD

The present disclosure relates to an information processing system and an information processing method.

### BACKGROUND

Technology in which a second terminal displays a virtual space including a first avatar corresponding to a first user and a second avatar corresponding to a second user, and operates the first avatar based on a selected operation pattern and operates the second avatar based on second video data that images the second user is known. For example, see Patent Literature (PTL) 1.

### CITATION LIST

### Patent Literature

PTL 1: WO 2020/203999 A1

### SUMMARY

When users have direct dialogues, nonverbal communication occurs simultaneously in addition to verbal communication. However, there is room for improvement for adequate communication in remote dialogues in which an interlocutor is fixedly displayed on a screen.

It would be helpful to facilitate nonverbal communication other than speech to enable smooth dialogues.

An information processing system according to an embodiment of the present disclosure is an information processing system including a plurality of terminal apparatuses each located at a predetermined distance from each of a plurality of users,

wherein

the plurality of terminal apparatuses includes a first terminal apparatus located at a predetermined distance from a first user, a second terminal apparatus located at a predetermined distance from a second user, and a third terminal apparatus located at a predetermined distance from a third user,

each of the plurality of terminal apparatuses is configured to display, on a display, an image of each of other users, and

the first terminal apparatus is configured to detect and transmit, to the third terminal apparatus, first distance information between the first user and the second user who is displayed on the display of the first terminal apparatus.

An information processing method according to an embodiment of the present disclosure is an information processing method by a plurality of terminal apparatuses each located at a predetermined distance from each of a plurality of users, the plurality of terminal apparatuses including a first terminal apparatus located at a predetermined distance from a first user, a second terminal apparatus located at a predetermined distance from a second user, and a third terminal apparatus located at a predetermined distance from a third user, the information processing method including:

displaying on a display, by each of the plurality of terminal apparatuses, an image of each of other users; and

detecting and transmitting to the third terminal apparatus, by the first terminal apparatus, first distance information between the first user and the second user who is displayed on the display of the first terminal apparatus.

According to an embodiment of the present disclosure, it is possible to facilitate nonverbal communication other than speech to enable smooth dialogues.

### BRIEF DESCRIPTION OF THE DRAWINGS

In the accompanying drawings:

FIG. 1 is a schematic diagram of an information processing system;

FIG. 2 is a block diagram illustrating a configuration of a first terminal apparatus;

FIG. 3 is a diagram illustrating a first scene of a remote dialogue;

FIG. 4 is a diagram illustrating a second scene of the remote dialogue;

FIG. 5 is a diagram illustrating a third scene of the remote dialogue;

and

FIG. 6 is a sequence diagram illustrating operations performed by the information processing system.

### DETAILED DESCRIPTION

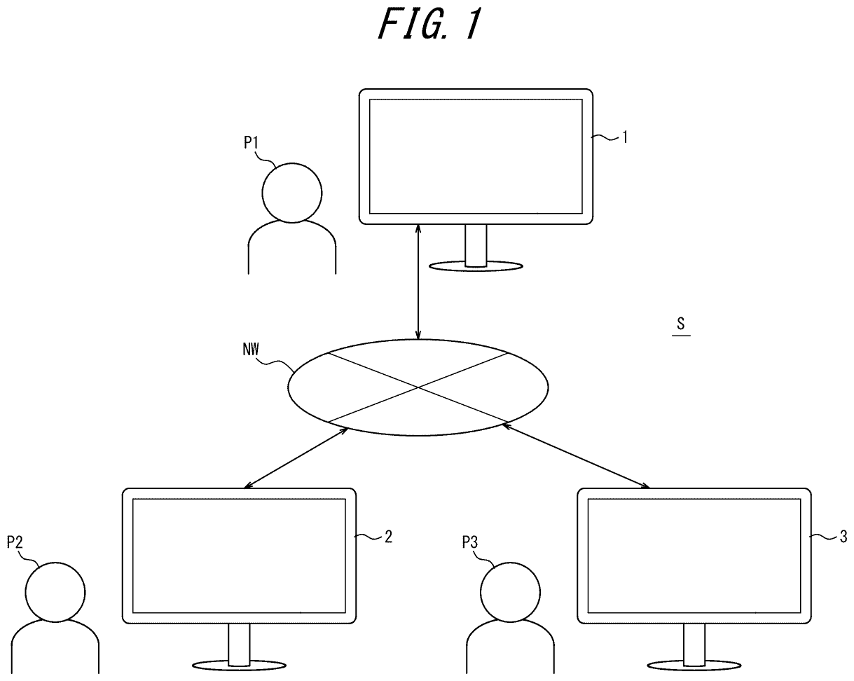

FIG. 1 is a schematic diagram of an information processing system S according to the present embodiment. The information processing system S includes a first terminal apparatus 1, a second terminal apparatus 2, and a third terminal apparatus 3, which are communicably connected to each other via a network NW. The network NW includes, for example, a mobile communication network, a fixed communication network, or the Internet. The first terminal apparatus 1 is used by a first user P1. The second terminal apparatus 2 is used by a second user P2. The third terminal apparatus 3 is used by a third user P3. Each of the first terminal apparatus 1, second terminal apparatus 2, and third terminal apparatus 3 is located at a predetermined distance from each of the first user P1, second user P2, and third user P3.

FIG. 1 illustrates three of the terminal apparatuses for convenience of explanation. However, the number of the terminal apparatuses is not limited to this.

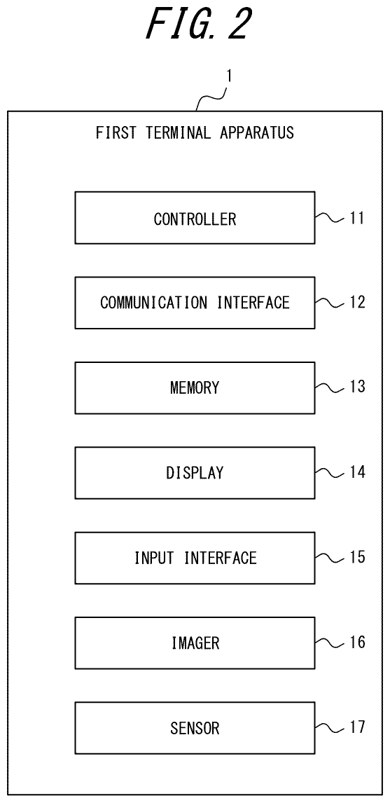

With reference to FIG. 2, an internal configuration of the first terminal apparatus 1 is described in detail.

The first terminal apparatus 1 may be, for example, a general purpose device such as a PC, or a dedicated device. The term “PC” is an abbreviation of personal computer. As an alternative example, the first terminal apparatus 1 may be a mobile device such as a mobile phone, a smartphone, a wearable device, or a tablet.

The first terminal apparatus 1 includes a controller 11, a communication interface 12, a memory 13, a display 14, an input interface 15, an imager 16, and a sensor 17. The components of the first terminal apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes one or more communication modules for connection to the network NW that conform to wired or wireless Local Area Network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth® is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network NW.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may also store various types of information, etc., regarding operations and control of the first terminal apparatus 1. The memory 13 may store a system program, an application program, embedded software, and the like. The memory 13 may be provided outside the first terminal apparatus 1 and accessed by the first terminal apparatus 1.

The display 14 is, for example, a display. The display is, for example, an LCD or an organic EL display. The term “LCD” is an abbreviation of liquid crystal display. The term “EL” is an abbreviation of electro luminescence. The display 14, instead of being included in the first terminal apparatus 1, may be connected to the first terminal apparatus 1 as an external output device. As a connection method, any technology such as USB, HDMI® (HDMI is a registered trademark in Japan, other countries, or both), or Bluetooth® can be used.

The input interface 15 is, for example, a physical key, a capacitive key, a pointing device, a touch screen integrally provided with a display, or a microphone. The input interface 15 accepts an operation for inputting information to be used for the operations of the first terminal apparatus 1. The input interface 15, instead of being included in the first terminal apparatus 1, may be connected to the first terminal apparatus 1 as an external input device. As a connection method, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface.

The imager 16 includes a camera. The imager 16 can capture images of its surroundings. The imager 16 may store the captured images in the memory 13 or transmit the captured images to the controller 11 for the purpose of image analysis. The images include still or moving images.

The sensor 17 may be, for example, a distance-measuring sensor. The imager 16 and sensor 17 may be external. In this case, for example, the imager 16 and sensor 17 meet the requirements of the present embodiment if their position with the first terminal apparatus 1 is known.

The second terminal apparatus 2 includes a controller 21, a communication interface 22, a memory 23, a display 24, an input interface 25, an imager 26, and a sensor 27. The third terminal apparatus 3 includes a controller 31, a communication interface 32, a memory 33, a display 34, an input interface 35, an imager 36, and a sensor 37. A description of the hardware configuration of each of the second terminal apparatus 2 and third terminal apparatus 3 may be the same as the description of the hardware configuration of the first terminal apparatus 1. An explanation here is omitted.

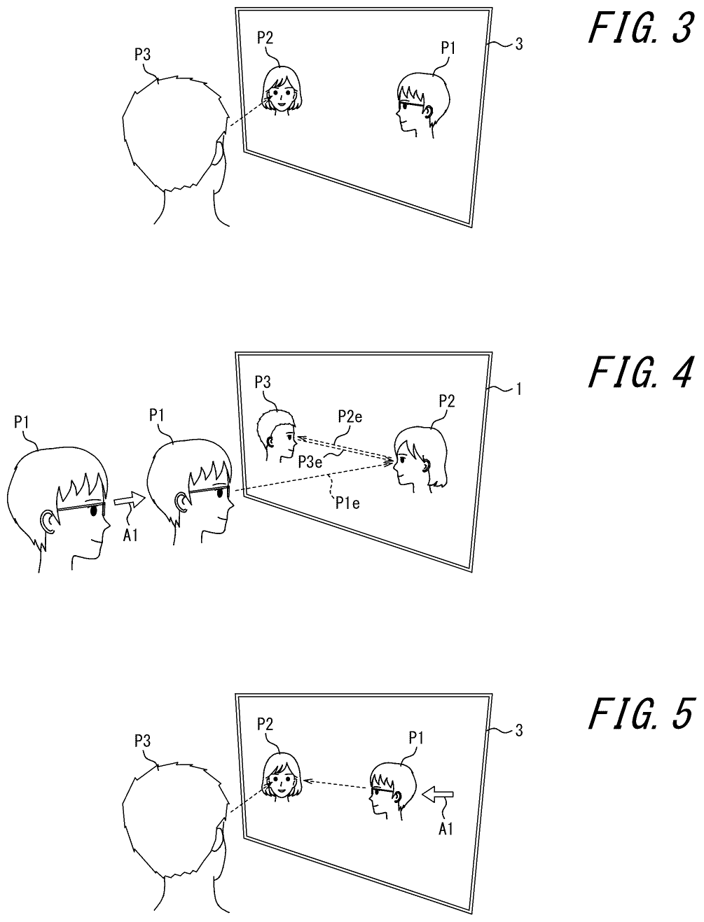

Hereinafter, an information processing method executed by the information processing system S will be described in detail. As an example here, the first user P1, the second user P2, and the third user P3, each located in a different location, conduct a dialogue using the information processing system S. As an example, the dialogue is a remote dialogue. The number of people conducting the dialogue can be any number of people as long as there is more than one. Each user's terminal apparatus captures images of the user using the terminal apparatus with the imager 26, and sequentially transmits the captured images to the other users' terminal apparatuses. Each user's terminal apparatus displays images (e.g., 3D models) of each of the other users on its display during the execution of the remote dialogue. As illustrated in FIG. 3, the third terminal apparatus 3 of the third user P3 displays the first user P1 and the second user P2 on the display 34. In FIG. 3, the second user P2 and the third user P3 are looking at each other. Therefore, in FIG. 4, the line of sight P2e of the second user P2 is aligned with the line of sight P3e of the third user P3.

As illustrated in FIG. 4, the first user P1 approaches the second user P2 in the direction of arrow A1, looking at the second user P2 along the line of sight P1e. The controller 11 of the first terminal apparatus 1 sequentially detects, using the sensor 17, first distance information indicating the first distance between the position of the first user P1 (e.g., the position of the face of the first user P1) and the position of the 3D model of the second user P2 on the display 14. The controller 11 of the first terminal apparatus 1 sequentially transmits the detected first distance information to the third terminal apparatus 3 of the third user P3.

As an alternative example, the first terminal apparatus 1 may detect and transmit the first distance information between the position of the first user P1 and the position of the second user P2 on the display 14 only while the first user P1 is looking at the second user P2 on the display 14 (i.e., while the line of sight or face of the first user P1 is directed toward the second user P2 on the display 14). In other words, the first terminal apparatus 1 does not detect and transmit the first distance information while the first user P1 is not looking at the second user P2.

The controller 31 of the third terminal apparatus 3 of the third user P3 adjusts the distance information indicating the distance on the display 34 between the 3D model of the first user P1 and the 3D model of the second user P2 based on the first distance information sequentially transmitted from the first terminal apparatus 1. Adjustment is to shorten or lengthen the distance. Therefore, as the first user P1 approaches the second user P2 in the direction of arrow A1 as illustrated in FIG. 4, in the third terminal apparatus 3 in FIG. 5, the first user P1 approaches the second user P2 in the direction of arrow A1. For example, the controller 31 may increase or decrease (e.g., decrease by 10%) the distance information between the 3D model of the first user P1 and the 3D model of the second user P2 on the display 34 according to the rate (e.g., decrease by 10%) at which the first distance information between the position of the first user P1 and the 3D model of the second user P2 has increased or decreased. The controller 31 of the third terminal apparatus 3 may adjust the distance information between the first user P1 and the second user P2 on the display 34 to be shorter, the shorter the first distance information transmitted from the first terminal apparatus 1 is. As an alternative example, the controller 31 may increase or decrease the distance information between the 3D model of the first user P1 and the 3D model of the second user P2 on the display 34 according to a value at which the first distance information has increased or decreased.

As an additional example, the second terminal apparatus 2 may sequentially detect and transmit, to the third terminal apparatus 3, second distance information indicating the second distance between the position of the second user P2 and the position of the first user P1 on the display 24 of the second terminal apparatus 2. In this case, the third terminal apparatus 3 may adjust the distance information between the first user P1 and the second terminal apparatus 2 on the display 34 based on the total distance of the first distance information sequentially transmitted from the first terminal apparatus 1 and the second distance information sequentially transmitted from the second terminal apparatus 2. For example, the controller 31 may increase or decrease (e.g., decrease by 10%) the distance information between the 3D model of the first user P1 and the 3D model of the second user P2 on the display 34 according to the rate (e.g., decrease by 10%) at which the total distance has increased or decreased.

The above embodiment describes a case in which the first user P1 approaches the second user P2 and the distance information is adjusted at the third terminal apparatus 3 of the third user P3. However, the first user P1, second user P2, and third user P3 can be arbitrarily interchanged.

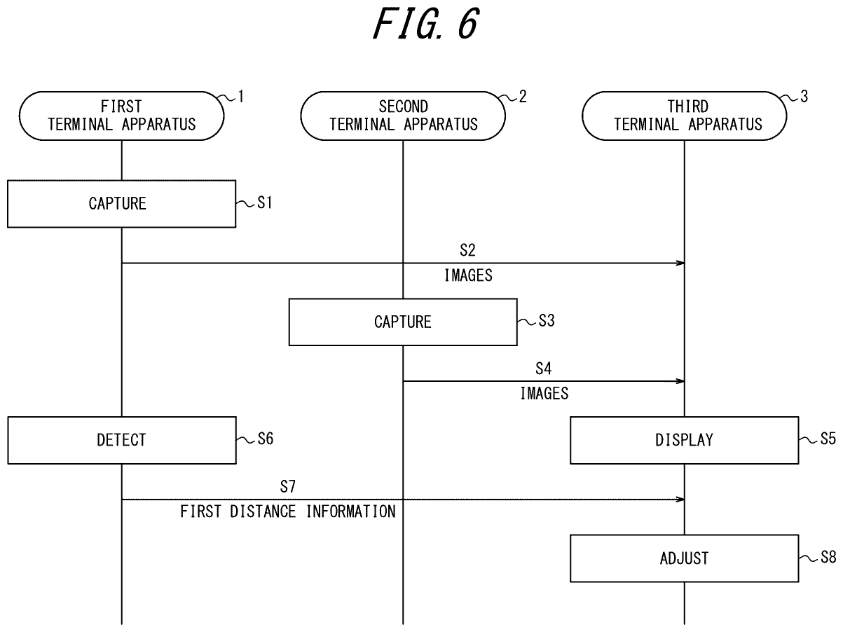

Referring to FIG. 6, an information processing method executed by the information processing system S at any given point in time is described.

In step S1, the first terminal apparatus 1 captures images of the first user P1. In step S2, the first terminal apparatus 1 transmits the captured images to the third terminal apparatus 3.

In step S3, the second terminal apparatus 2 captures images of the second user P2. In step S4, the second terminal apparatus 2 transmits the captured images to the third terminal apparatus 3. Steps S3 and S4 may be performed before steps S1 and S2.

In step S5, the third terminal apparatus 3 displays a 3D model of the first user P1 and a 3D model of the second user P2 on the display 34 according to the received captured images.

In step S6, the first terminal apparatus 1 detects first distance information between the first user P1 and the second user P2 on the display 14. In step S7, the first terminal apparatus 1 transmits the first distance information to the third terminal apparatus 3.

In step S8, the third terminal apparatus 3 adjusts distance information indicating the distance between the first user P1 and the second user P2 on the display 34 of the third terminal apparatus 3 based on the first distance information transmitted from the first terminal apparatus 1.

As described above, according to the present embodiment, the third terminal apparatus 3 adjusts the distance information between the first user P1 and the second user P2 on the display 14 of the third terminal apparatus 3 based on the first distance information transmitted from the first terminal apparatus 1. This configuration allows the information processing system S to enable the third user P3 to see a change (fluctuation) in the distance between the first user P1 and the second user P2. The information processing system S thus can facilitate nonverbal communication other than speech to enable smooth dialogues.

According to the present embodiment, the third terminal apparatus 3 adjusts the distance information between the first user P1 and the second user P2 to be shorter on the display 14 of the third terminal apparatus 3, the shorter the first distance information transmitted from the first terminal apparatus 1 is. With this configuration, for example, when the first user P1 approaches or moves away from the second user P2 on the display 14, the third user can see the distance between the first user P1 and the second user P2 on the display 34 shorten or lengthen. Thus, the information processing system S can make it easier for the third user P3 to understand the distance of the first user P1 to the second user P2.

According to the present embodiment, the third terminal apparatus 3 adjusts the distance information between the first user P1 and the second user P2 on the display 34 of the third terminal apparatus 3 based on the total distance of the first distance information transmitted from the first terminal apparatus 1 and the second distance information transmitted from the second terminal apparatus 2. This configuration allows the information processing system S to make it easier for the third user P3 to understand the distance of the first user P1 and the second user P2 to each other.

According to the present embodiment, the first terminal apparatus 1 detects and transmits the first distance information only while the first user P1 is looking at the second user P2 on the display 14. This configuration allows the information processing system S to reduce the possibility of the distance between the first user P1 and the second user P2 changing on the display 34 of the third terminal apparatus 3, for example, when the first user P1 changes his/her posture independently of the second user P2.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the above embodiment, a program that executes all or part of the functions or processing of the first terminal apparatus 1, the second terminal apparatus 2, or the third terminal apparatus 3 may be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read the program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

1. An information processing system comprising a plurality of terminal apparatuses each located at a predetermined distance from each of a plurality of users,
wherein
the plurality of terminal apparatuses comprises a first terminal apparatus located at a predetermined distance from a first user, a second terminal apparatus located at a predetermined distance from a second user, and a third terminal apparatus located at a predetermined distance from a third user,
each of the plurality of terminal apparatuses is configured to display, on a display, an image of each of other users, and
the first terminal apparatus is configured to detect and transmit, to the third terminal apparatus, first distance information between the first user and the second user who is displayed on the display of the first terminal apparatus.

2. The information processing system according to claim 1, wherein the third terminal apparatus is configured to adjust, based on the first distance information transmitted from the first terminal apparatus, distance information between the first user and the second user who are displayed on the display of the third terminal apparatus.

3. The information processing system according to claim 2, wherein the third terminal apparatus is configured to adjust the distance information between the first user and the second user who are displayed on the display of the third terminal apparatus to be shorter, the shorter the first distance information transmitted from the first terminal apparatus is.

4. The information processing system according to claim 1, wherein
the second terminal apparatus is configured to detect and transmit, to the third terminal apparatus, second distance information between the second user and the first user who is displayed on the display of the second terminal apparatus, and
the third terminal apparatus is configured to adjust a distance between the first user and the second user who are displayed on the display of the third terminal apparatus, based on a total distance of the first distance information transmitted from the first terminal apparatus and the second distance information.

5. The information processing system according to claim 1, wherein the first terminal apparatus is configured to detect and transmit the first distance information only while the first user is looking at the second user who is displayed on the display of the first terminal apparatus.

6. An information processing method by a plurality of terminal apparatuses each located at a predetermined distance from each of a plurality of users, the plurality of terminal apparatuses comprising a first terminal apparatus located at a predetermined distance from a first user, a second terminal apparatus located at a predetermined distance from a second user, and a third terminal apparatus located at a predetermined distance from a third user, the information processing method comprising:
displaying on a display, by each of the plurality of terminal apparatuses, an image of each of other users; and
detecting and transmitting to the third terminal apparatus, by the first terminal apparatus, first distance information between the first user and the second user who is displayed on the display of the first terminal apparatus.
